(19) United States
(12) Patent Application Publication
(10) Pub. No.: US 2017/0147092 A1
(43) Pub. Date: May 25, 2017

(54) AIR MOUSE REMOTE CONTROLLER OPTIMIZATION METHOD AND APPARATUS, AIR MOUSE REMOTE CONTROLLER, AND STORAGE MEDIUM

(71) Applicant: Xiaomi Inc., Beijing (CN)

(72) Inventors: Xin LIANG, Beijing (CN); Kangxi TAN, Beijing (CN)

(21) Appl. No.: 15/244,642

(22) Filed: Aug. 23, 2016

(30) Foreign Application Priority Data
Nov. 20, 2015 (CN) 201510809884.X

(51) Int. Cl. G06F 3/0346; G06F 3/0354

(52) U.S. Cl. CPC G06F 3/0346; G06F 3/03543

(57) ABSTRACT

An air mouse remote controller includes a control module, an air mouse module, and a movement sensor connected to the air mouse module and configured to collect a movement trajectory of the controller. The air mouse module performs an air mouse function according to the movement trajectory and generates an air mouse control signal. The control module sends the air mouse control signal to a terminal device to control movement of a corresponding cursor. A key assembly includes a two-stage key. When detecting that the two-stage key is pressed to its first stage, the control module sends a selection instruction to the terminal device to fix the cursor at its current position, and when detecting that the two-stage key is pressed to its second stage, the control module sends an operation instruction to the terminal device to execute an operation corresponding to the position of the cursor.

### CROSS-REFERENCE TO RELATED APPLICATIONS

This application is based upon and claims priority to Chinese Patent Application No. 201510809884.X, filed on Nov. 20, 2015, the entire contents of which are incorporated herein by reference.

### TECHNICAL FIELD

The present disclosure generally relates to smart devices, and more particularly, to an air mouse remote controller optimization method and apparatus, an air mouse remote controller, and a storage medium.

### BACKGROUND ART

With the development of smart household equipment industry, air mouse remote controllers are used more widely, and are replacing traditional remote controllers for controlling terminal devices such as smart TVs. A typical air mouse remote controller uses a movement sensor to identify movement trajectories, and simulates mapping operations between a mouse and a cursor on a screen of a terminal device. Through mapping movement of an air mouse remote controller with an operation interface on a screen, a corresponding operation is selected via the cursor when a user presses a key. However, because a displacement of the user's hand may be generated when the user presses a key, a movement sensor may detect the movement of the hand and cause a change of a selected position of the cursor mapped on the screen. As a result, the accuracy of key pressing operations is low and user experience is poor.

### SUMMARY

According to a first aspect of the present disclosure, there is provided an air mouse remote controller. The air mouse remote controller includes a control module, an air mouse module, a movement sensor connected to the air mouse module and configured to collect a movement trajectory of the air mouse remote controller, a wireless communication module, a key assembly, and a power module. The air mouse module, the wireless communication module, the key assembly, and the power module are connected to the control module. The air mouse module is configured to perform an air mouse function according to the movement trajectory and generate an air mouse control signal. The control module is configured to send the air mouse control signal to a terminal device via the wireless communication module to control movement of a corresponding cursor. The key assembly includes a two-stage key having a microswitch. When detecting that the two-stage key is pressed to its first stage, the control module is configured to send a selection instruction to the terminal device via the wireless communication module to fix the cursor at its current position. When detecting that the two-stage key is pressed to its second stage, the control module sends an operation instruction to the terminal device via the wireless communication module such that the terminal device executes an operation corresponding to the position of the cursor.

According to a second aspect of the present disclosure, there is provided an air mouse remote controller optimization method. The method includes receiving a selection instruction sent by an air mouse remote controller. The method also includes locking a cursor corresponding to the air mouse remote controller at its current position on an operation interface, according to the selection instruction. The method further includes executing an operation corresponding to a widget at the current position where the cursor is locked, when receiving an operation instruction sent by the air mouse remote controller.

According to a third aspect of the present disclosure, there is provided a non-transitory computer-readable storage medium having stored therein instructions that, when executed by a processor of a mobile terminal, cause the mobile terminal to perform an air mouse remote controller optimization method. When detecting that a two-stage key is pressed to its first stage, the method includes sending a selection instruction to a terminal device such that the terminal device locks a cursor at its position. When detecting that the two-stage key is pressed to its second stage, the method includes sending an operation instruction to the terminal device such that the terminal device executes an operation corresponding to a widget at the position where the cursor is locked.

It should be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of an air mouse remote controller according to an exemplary embodiment.

FIG. 2 is a flowchart showing an air mouse remote controller optimization method according to an exemplary embodiment.

FIG. 3 is a flowchart showing an air mouse remote controller optimization method according to an exemplary embodiment.

FIG. 4 is a block diagram of an air mouse remote controller optimization apparatus according to an exemplary embodiment.

FIG. 5 is a block diagram of a terminal device according to an exemplary embodiment.

FIG. 6 is a block diagram of a terminal device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise presented. The embodiments set forth in the following description of exemplary embodiments do not represent all embodiments consistent with the invention. Instead, they are merely examples of apparatuses and methods consistent with aspects related to the invention as recited in the appended claims.

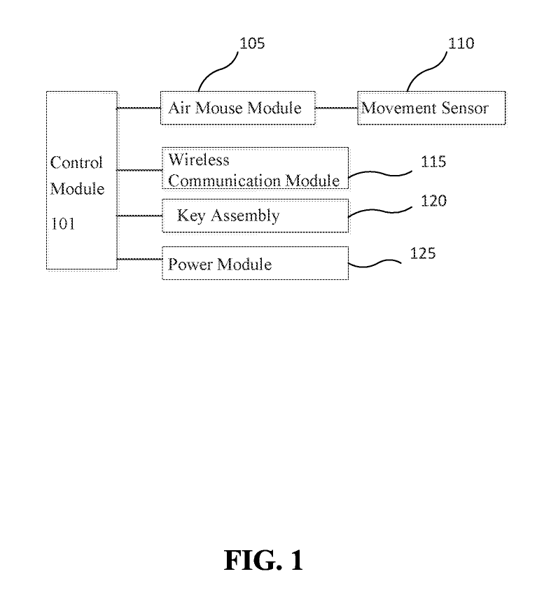

FIG. 1 is a schematic diagram of an air mouse remote controller according to an exemplary embodiment. As shown in FIG. 1, the air mouse remote controller includes a control module 101, an air mouse module 105, a movement sensor 110, a wireless communication module 115, a key assembly 120, and a power module 125. The power module 125 is configured to supply power to the control module 101 and other components connected to the control module 101. It should be understood that any “module” disclosed in the application can be implemented using hardware components, software, or both.

The movement sensor 110 is connected to the air mouse module 105. The air mouse module 105, the wireless communication module 115, the key assembly 120, and the power module 125 are connected to the control module 101, respectively. The movement sensor 110 is configured to collect a movement trajectory of the air mouse remote controller. The air mouse module 105 is configured to perform an air mouse function according to the movement trajectory and generates an air mouse control signal. The control module 101 sends the air mouse control signal to a terminal device via the wireless communication module 115 to control movement of a corresponding cursor.

The key assembly 120 includes a two-stage key having a microswitch. When detecting that the two-stage key is pressed to its first stage, the control module 101 sends a selection instruction to the terminal device via the wireless communication module 115 to fix the cursor at its current position. When detecting that the two-stage key is pressed to its second stage, the control module 101 sends an operation instruction to the terminal device via the wireless communication module 115 such that the terminal device executes an operation corresponding to the position of the cursor.

In an embodiment of the present disclosure, the control module 101 is realized by a single chip or a general purpose processor in combination with the related applications. The movement sensor 110 is realized by a gyro.

A gyro is an angular movement detecting device, which can measure a rotational angular speed around an axis and derive a rotational angle around the axis. Gyros are widely used due to their two basic features: fixed axis and precession, which are based on the principle of conservation of angular momentum. There are many types of gyros, including directional gyros, gyro compasses, gyro vertical instruments, gyro stabilizers, rate gyros, gyro stabilized platforms, gyro sensors, fiber optic gyros, laser gyros, Micro-Electro-Mechanical Systems (MEMS) gyros etc. Gyro sensors are positioning and control systems based on free spatial movement and gestures, and are already widely used in mobile or portable devices such as smart cell phones and smart TV remote controllers. A gyro sensor can be moved on an imaginary plane to move a cursor, draw circles around a link, and click keys or buttons. Gyro sensors can expand game potentials and enhance user experience.

In some embodiments, the wireless communication module 115 includes at least one of a Bluetooth communication unit, an infrared communication unit, or a 2.4 GHz wireless communication unit.

To realize communication between the air mouse remote controller and the controlled terminal device, infrared signal transmission or Bluetooth transmission can be used. When Bluetooth transmission is used, a Bluetooth connection is established between the air mouse remote controller and the terminal device. In some embodiments, wireless communication at a dedicated 2.4 GHz public frequency band can be used, which has a much lower probability of frequency interference than that of frequency bands used by traditional remote controllers. In addition, because the linearity of electromagnetic waves of 2.4 GHz is good, the antenna of the air mouse remote controller can be made short, making the air mouse remote controller convenient to use. Further, there are many usable frequency points for 2.4 GHz remote controllers. Moreover, the diffraction ability of radio waves at 2.4 GHz is strong. Accordingly, control can be maintained when such radio waves encounter obstacles.

In addition, in some embodiments, the air mouse remote controller further includes a housing inside which the control module 101, the air mouse module 105, the movement sensor 110, the wireless communication module 115, and the power module 125 are disposed. The key assembly 120 is disposed on an outer side of the housing. The confirmation key and/or other keys of the air mouse remote controller may be provided as two-stage keys having microswitches for users' operations.

In some embodiments, the air mouse remote controller further includes an indication lamp disposed on the housing and connected to the power module.

In addition to the control module 101 and the air mouse module 105, the air mouse remote controller also includes features such as a two-stage key. When the two-stage key is pressed to its first stage by a user, the wireless communication module 115 sends a selection instruction to cause the terminal device to fix a position of the cursor. When the two-stage key is pressed to its second stage afterwards, movement of the user's hand will not cause movement of the cursor, and a widget selected by the cursor will be executed. As a result, the effect of movement of the user's hand when pressing a key is reduced, and the accuracy of key pressing operations and the user experience are improved.

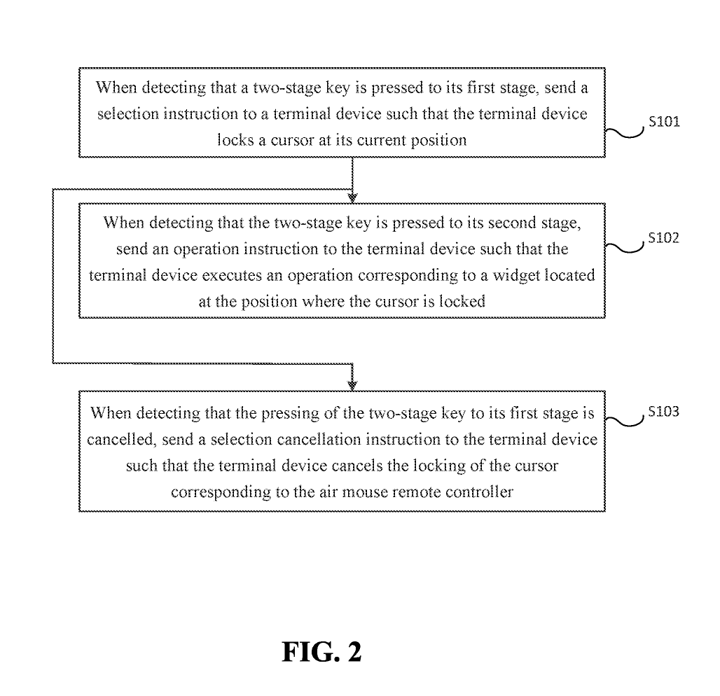

FIG. 2 is a flowchart showing an air mouse remote controller optimization method according to an exemplary embodiment. As shown in FIG. 2, the optimization method is executed by the air mouse remote controller shown in FIG. 1 and includes the following steps.

In Step S101, when detecting that the two-stage key is pressed to its first stage, a selection instruction is sent to the terminal device such that the terminal device locks a cursor at its current position.

In this step, the two-stage key of the air mouse remote controller can detect an operation magnitude of the user's operation on the key. The two-stage key is analogous to a two-stage shutter key of a camera. The key only needs to be slightly pressed to its first stage, so that a corresponding response message can be sent to the control module. The control module generates a selection instruction based on this message and sends the selection instruction to the remotely controlled terminal device through Bluetooth, a wireless network, near field communication, infrared transmission or the like.

The selection instruction is used to instruct the terminal device to lock the current position of the cursor, so that the terminal device can fix the cursor corresponding to the air mouse remote controller at the current position. In other words, before the pressing of the two-stage key to its first stage is cancelled, the cursor will not move along with movement of the air mouse remote controller.

In Step S102, when detecting that the two-stage key is pressed to its second stage, an operation instruction is sent to the terminal device such that the terminal device executes an operation corresponding to a widget at the position where the cursor is locked.

In this step, when it is further detected by the air mouse remote controller that the two-stage key is pressed to its second stage, it is deemed that the user wants to operate the currently selected widget. Similar to the above operations, the control module generates an operation instruction instructing the terminal device to execute the currently selected widget. In use of the two-stage key, a greater force is required for pressing the two-stage key to its second stage, and therefore displacement of the user's hand is larger. By applying the disclosed solution, it can be ensured that, when the two-stage key is pressed further to its second stage, the position of the cursor is fixed and the currently selected widget does not change.

In Step S103, when detecting that the pressing of the two-stage key to its first stage is cancelled, a selection cancellation instruction is sent to the terminal device such that the terminal device cancels the locking of the cursor corresponding to the air mouse remote controller.

Steps S103 and S102 are in parallel. That is, if the user presses the two-stage key to its first stage and presses the two-stage key to its second stage afterwards, Step S102 will be executed. If the user presses the two-stage key to its first stage and cancels the pressing afterwards, Step S103 will be executed.

If the user releases the two-stage key that is pressed to its first stage, it is deemed that the user abandons the operation, and the control module generates a selection cancellation instruction and sends it to the terminal device such that the terminal device cancels the locking of the cursor. Afterwards, the cursor continues to move on the operation interface of the terminal device according to the movement of the air mouse remote controller, and selects a new widget based on the user's operations.

In addition, after Step S102 is executed, that is, after the widget on the terminal device is executed, there is no need to lock the cursor. Instead, the locking is cancelled, so that the cursor continues to move on the operation interface according to the movement of the air mouse remote controller.

The air mouse remote controller optimization method provided by this embodiment is based on the air mouse remote controller shown in FIG. 1. By detecting a state of the key, different control instructions are sent to the terminal device according to different states. To be specific, when the user presses the two-stage key to its first stage, a selection instruction is sent to cause the terminal device to lock the position of the cursor. When the two-stage key is pressed to its second stage, an operation instruction is sent. As such, a distance moved by the cursor due to movement of the user's hand when operating the key is reduced, and the accuracy of widget selection and the user experience are improved.

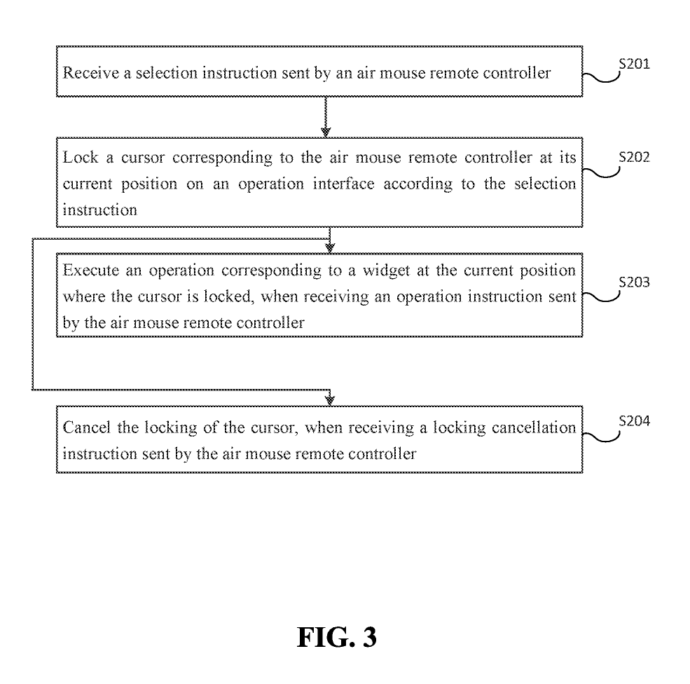

FIG. 3 is a flowchart showing an air mouse remote controller optimization method according to an exemplary embodiment. As shown in FIG. 3, the optimization method is executed by a remotely controlled terminal device side such as a smart TV or a projector, and includes the following steps.

In Step S201, a selection instruction sent by an air mouse remote controller is received.

In Step S202, a cursor corresponding to the air mouse remote controller is locked at its current position on an operation interface according to the selection instruction.

In Step S203, an operation corresponding to a widget at the current position where the cursor is locked is executed, when receiving an operation instruction sent by the air mouse remote controller.

Optionally, in Step S204, the locking of the cursor is cancelled, when receiving a locking cancellation instruction sent by the air mouse remote controller.

In the disclosed solution, the terminal device can fix the position of the cursor on the operation interface after receiving a selection instruction sent by an air mouse remote controller, and execute a selected widget after receiving an operation instruction, or cancel the locking of the cursor after receiving a locking cancellation instruction.

In the disclosed solution, Steps S203 and S204 are in parallel and one of them is executed according to the instruction type. In other words, the confirmation key of the air mouse remote controller is provided as a two-stage key having a microswitch. If the user presses the two-stage key to its first stage, the terminal device freezes the air mouse or movement of the air mouse cursor, so that the accuracy of the key pressing operations of the air mouse is improved significantly.

The air mouse remote controller optimization methods of the disclosed embodiments can be performed by the terminal device. The improved air mouse remote controller differs from existing air mouse remote controllers in that instructions are sent twice before an operation is executed. Thus, the corresponding terminal device needs to receive instructions twice. After the selection instruction is received, the cursor is locked at a position on an operation interface. If an operation instruction is received afterwards, an operation corresponding to a widget at the position of the cursor is executed. If a locking cancellation instruction is received, the locking of the cursor is cancelled, so that the cursor can continue to move, thereby improving the user experience.

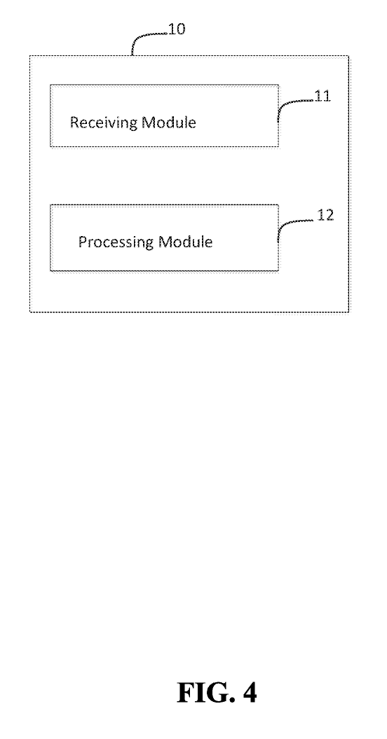

FIG. 4 is a block diagram of an air mouse remote controller optimization apparatus 10 according to an exemplary embodiment. As shown in FIG. 4, the air mouse remote controller optimization apparatus 10 includes a receiving module 11 configured to receive a selection instruction sent by an air mouse remote controller. The air mouse remote controller optimization apparatus 10 also includes a processing module 12 configured to lock a cursor corresponding to the air mouse remote controller at its current position on an operation interface according to the selection instruction. The processing module 12 is configured to execute an operation corresponding to a widget at the locked current position where the cursor is locked when the receiving module 11 receives an operation instruction sent by the air mouse remote controller.

Optionally, the processing module 12 is also configured to cancel the locking of the cursor when the receiving module 11 receives a locking cancellation instruction sent by the air mouse remote controller.

With respect to the air mouse remote controller optimization apparatus in the above embodiments, the specific manners of performing operations by individual modules therein have been described in detail in the above discussions of the steps shown in FIG. 3 and will not be elaborated herein.

The air mouse remote controller optimization apparatus of the disclosed embodiment is equivalent to a terminal device. The improved air mouse remote controller requires the receiving module to receive instructions twice. After receiving the selection instruction, the cursor is locked at a position on an operation interface. If an operation instruction is received afterwards, an operation corresponding to a widget at the position of the cursor is executed by the processing module. If a locking cancellation instruction is received, the locking of the cursor is cancelled by the processing module, so that the cursor can continue to move. By providing a two-stage key to the air mouse remote controller, inaccurate cursor selection due to movement of the user's hand during an operating process is avoided, and the selection accuracy of the air mouse remote controller is improved, thereby improving the user experience.

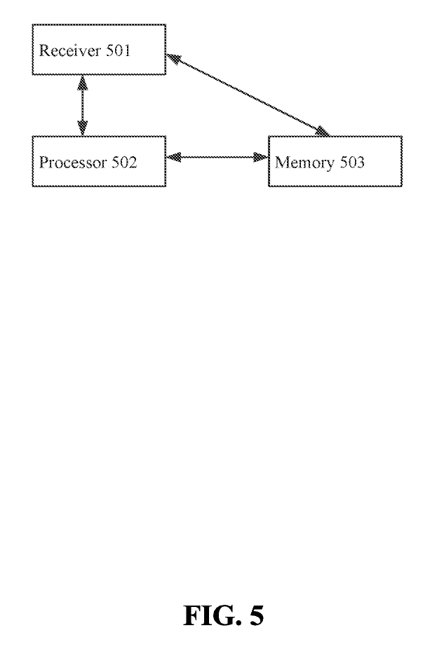

The above describes the air mouse remote controller optimization apparatus, namely, the internal functional modules and the schematic structures of the terminal device. FIG. 5 is a block diagram of a physical implementation of a terminal device according to an exemplary embodiment. Referring to FIG. 5, the terminal device includes a receiver 501 configured to receive a message, a processor 502 configured to control execution of executable instructions, and a memory 503 configured to store instructions executable by the processor 502. The receiver 501 is also configured to receive a selection instruction sent by an air mouse remote controller. The processor 502 is also configured to lock a cursor corresponding to the air mouse remote controller at its current position on an operation interface according to the selection instruction. The processor 502 is further configured to execute an operation corresponding to a widget at the current position where the cursor is locked when the receiver receives an operation instruction sent by the air mouse remote controller.

The processor 502 is also configured to cancel the locking of the cursor when the receiver 501 receives a locking cancellation instruction sent by the air mouse remote controller. The memory 503 is configured to store various data, such as instructions executable by the processor 502.

It should be understood that, in the embodiments of the above terminal device, the processor 502 can be a central processing unit (CPU), a general purpose processor, a digital signal processor (DSP), an application specific integrated circuit (ASIC) or the like. The general purpose processor can be a microprocessor or any one of a conventional processor. The memory 503 can be a read-only memory ROM, a random access memory RAM, a flash memory, a hard disc or a solid-state hard disc. The steps of the methods disclosed by the embodiments of this invention can be executed by a hardware processor or by a combination of hardware and software modules of the processor.

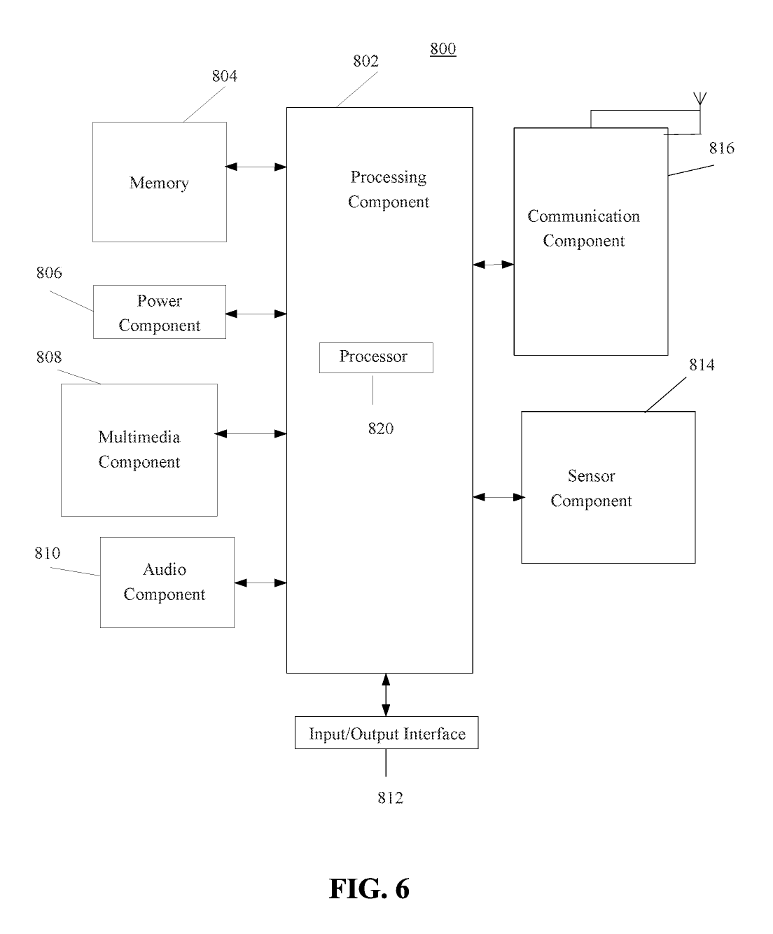

FIG. 6 is a block diagram of a terminal device 800 according to an exemplary embodiment. The terminal device 800 can be provided as a smart terminal, a smart TV, a projector, a computer, a digital broadcasting device, a messaging device, a game console, a tablet, a medical device, a fitness device, a personal digital assistant or the like.

Referring to FIG. 6, the terminal device 800 includes one or more of the following components: a processing component 802, a memory 804, a power supply component 806, a multimedia component 808, an audio component 810, an input/output (I/O) interface 812, a sensor component 814, and a communication component 816.

The processing component 802 is configured to control overall operations of the terminal device 800, such as the operations associated with display, telephone calls, data communications, camera operations, and recording operations. The processing component 802 includes one or more processors 820 configured to execute instructions to perform all or part of the steps included in the disclosed methods. In some embodiments, the processing component 802 includes one or more modules configured to facilitate the interaction between the processing component 802 and other components. For example, in some embodiments, the processing component 802 includes a multimedia module configured to facilitate the interaction between the multimedia component 808 and the processing component 802.

The memory 804 is configured to store various types of data to support the operation of the terminal device 800. Examples of such data include instructions for any applications or methods operated by the terminal device 800, contact data, phonebook data, messages, pictures, video, etc. The memory 804 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 is configured to provide power to various components of the terminal device 800. The power component 806 includes a power supply management system, one or more power sources, and any other components associated with the generation, management, and distribution of power in the terminal device 800.

The multimedia component 808 includes a screen providing an output interface between the terminal device 800 and the user. In some embodiments, the screen includes a liquid crystal display and a touch panel. If the screen includes the touch panel, the screen can be implemented as a touch screen configured to receive input signals from the user. The touch panel includes one or more touch sensors configured to sense touches, swipes, and gestures on the touch panel. The touch sensors not only sense a boundary of a touch or swipe action, but also sense a period of time and a pressure associated with the touch or swipe action. In some embodiments, the multimedia component 808 includes a front camera and/or a rear camera. The front camera and/or the rear camera can receive external multimedia data while the terminal device 800 is in an operation mode, such as a photographing mode or a video mode. Each of the front camera and the rear camera can be a fixed optical lens system or can have focus and optical zoom capability.

The audio component 810 is configured to output audio signals and/or receive input of audio signals. For example, the audio component 810 includes a microphone configured to receive an external audio signal when the terminal device 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output audio signals.

The I/O interface 812 is configured to provide an interface between the processing component 802 and peripheral interface modules, such as a keyboard, a click wheel, buttons, and the like. The buttons include, but are not limited to, a home button, a volume button, a starting button, and a locking button.

The sensor component 814 includes one or more sensors configured to provide status assessments of various aspects of the terminal device 800. For example, the sensor component 814 can detect an open/closed status of the terminal device 800, relative positioning of components, e.g., the display and the keypad, of the terminal device 800, a change in position of the terminal device 800 or a component of the terminal device 800, a presence or absence of user contact with the terminal device 800, an orientation or an acceleration/deceleration of the terminal device 800, and a change in temperature of the terminal device 800. In some embodiments, the sensor component 814 also includes a proximity sensor configured to detect the presence of nearby objects without any physical contact. In some embodiments, the sensor component 814 also includes a light sensor, such as a CMOS or CCD image sensor, for use in imaging applications. In some embodiments, the sensor component 814 also includes an accelerometer sensor, a gyroscope sensor, a magnetic sensor, a pressure sensor, or a temperature sensor.

The communication component 816 is configured to facilitate wired or wirelessly communication between the terminal device 800 and other devices. The terminal device 800 can access a wireless network based on a communication standard, such as WiFi, 2G, 3G, 4G, or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module configured to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 800 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

The exemplary embodiments also provides a non-volatile computer-readable storage medium containing instructions, such as the memory 804 containing instructions executable by the processing component 820 of the terminal device 800 to perform the disclosed methods. For example, the non-volatile computer-readable storage medium can be a ROM, a RAM, a CD-ROM, a tape, a floppy disc, an optical data storage device or the like.

In some embodiments, the present disclosure provides a non-transitory computer-readable storage medium having instructions stored therein which, when executed by a processor of a mobile terminal, cause the mobile terminal to perform an air mouse remote controller optimization method. The method includes receiving a selection instruction sent by an air mouse remote controller. The method also includes locking a cursor corresponding to the air mouse remote controller at its current position on an operation interface according to the selection instruction. The method further includes executing an operation corresponding to a widget at the current position where the cursor is locked, when receiving an operation instruction sent by the air mouse remote controller.

Optionally, the method also includes cancelling the locking of the cursor when receiving a locking cancellation instruction sent by the air mouse remote controller.

Although features and elements are described above in particular combinations, one of ordinary skill in the art will appreciate that each feature or element may be used alone, or in any combination with the other feature and elements if no contradiction exists. Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. An air mouse remote controller, comprising:
a control module;
an air mouse module;
a movement sensor connected to the air mouse module and configured to collect a movement trajectory of the air mouse remote controller;
a wireless communication module;
a key assembly; and
a power module,
wherein the air mouse module, the wireless communication module, the key assembly, and the power module are connected to the control module,
wherein the air mouse module is configured to perform an air mouse function according to the movement trajectory and generate an air mouse control signal,
wherein the control module is configured to send the air mouse control signal to a terminal device via the wireless communication module to control movement of a corresponding cursor,
wherein the key assembly includes a two-stage key having a microswitch,
wherein when detecting that the two-stage key is pressed to its first stage, the control module is configured to send a selection instruction to the terminal device via the wireless communication module to fix the cursor at its current position, and
wherein when detecting that the two-stage key is pressed to its second stage, the control module sends an operation instruction to the terminal device via the wireless communication module such that the terminal device executes an operation corresponding to the position of the cursor.

2. The air mouse remote controller according to claim 1, wherein the movement sensor is a gyro.

3. The air mouse remote controller according to claim 1, wherein the wireless communication module includes at least one of a Bluetooth communication unit, an infrared communication unit, or a 2.4GHz wireless communication unit.

4. The air mouse remote controller according to claim 1, further comprising a housing inside which the control module, the air mouse module, the movement sensor, the wireless communication module, and the power module are disposed, wherein the key assembly is disposed on an outer side of the housing.

5. The air mouse remote controller according to claim 2, further comprising a housing inside which the control module, the air mouse module, the movement sensor, the wireless communication module, and the power module are disposed, wherein the key assembly is disposed on an outer side of the housing.

6. The air mouse remote controller according to claim 3, further comprising a housing inside which the control module, the air mouse module, the movement sensor, the wireless communication module, and the power module are disposed, wherein the key assembly is disposed on an outer side of the housing.

7. The air mouse remote controller according to claim 4, further comprising an indication lamp disposed on the housing and connected to the power module.

8. The air mouse remote controller according to claim 5, further comprising an indication lamp disposed on the housing and connected to the power module.

9. The air mouse remote controller according to claim 6, further comprising an indication lamp disposed on the housing and connected to the power module.

10. The air mouse remote controller according to claim 1, wherein when detecting that the pressing of the two-stage key to its first stage is cancelled, the control module is configured to send a selection cancellation instruction to the terminal device such that the terminal device cancels the fixing of the cursor.

11. An air mouse remote controller optimization method, comprising:
receiving a selection instruction sent by an air mouse remote controller;
locking a cursor corresponding to the air mouse remote controller at its current position on an operation interface, according to the selection instruction; and
executing an operation corresponding to a widget at the current position where the cursor is locked, when receiving an operation instruction sent by the air mouse remote controller.

12. The method according to claim 11, further comprising cancelling the locking of the cursor, when receiving a locking cancellation instruction sent by the air mouse remote controller.

13. A non-transitory computer-readable storage medium having stored therein instructions that, when executed by a processor of a mobile terminal, cause the mobile terminal to perform an air mouse remote controller optimization method, the method comprising:
when detecting that a two-stage key is pressed to its first stage, sending a selection instruction to a terminal device such that the terminal device locks a cursor at its position; and
when detecting that the two-stage key is pressed to its second stage, sending an operation instruction to the terminal device such that the terminal device executes an operation corresponding to a widget at the position where the cursor is locked.

14. The storage medium of claim 13, wherein the method further comprises: when detecting that the pressing of the two-stage key to its first stage is cancelled, sending a selection cancellation instruction to the terminal device such that the terminal device cancels the locking of the cursor corresponding to the air mouse remote controller.
